(19) United States
(12) Patent Application Publication
(10) Pub. No.: US 2015/0116501 A1
(43) Pub. Date: Apr. 30, 2015

(54) SYSTEM AND METHOD FOR TRACKING OBJECTS

(71) Applicants: Sony Network Entertainment International LLC, Los Angeles, CA (US); Sony Corporation, Tokyo (JP)

(72) Inventors: Charles McCoy, Coronado, CA (US); True Xiong, San Diego, CA (US)

(73) Assignees: Sony Network Entertainment International LLC, Los Angeles, CA (US); Sony Corporation, Tokyo (JP)

(21) Appl. No.: 14/067,671

(22) Filed: Oct. 30, 2013

(51) Int. Cl. H04N 5/232; H04N 5/247; H04N 7/18

(52) U.S. Cl. CPC H04N 5/23206; H04N 7/181; H04N 5/23216; H04N 5/247
USPC 348/169

(57) ABSTRACT

Various aspects of a system and a method for tracking one or more objects may comprise a network capable of communicatively coupling a plurality of cameras, a plurality of sensors, and a controlling device. The controlling device may receive metadata associated with the one or more objects. The metadata identifies the one or more objects. The controlling device may select a first set of cameras from the plurality of cameras to track the one or more objects based on the received metadata. The controlling device may enable tracking the one or more objects by the selected first set of cameras.

### FIELD

Various embodiments of the disclosure relate to an object tracking system. More specifically, various embodiments of the disclosure relate to a system and method for tracking objects using a digital camera.

### BACKGROUND

Object tracking systems track movement of an object. Object tracking systems are used in various applications such as security and surveillance systems, human-computer interfaces, medical imaging, video communication, and object recognition. Camera-based object tracking systems monitor spatial and temporal changes associated with an object being tracked. However, camera-based object tracking systems are limited to tracking objects visible in current field of view of the camera. Moreover, camera-based object tracking systems have limited capabilities for tracking multiple objects simultaneously.

Further limitations and disadvantages of conventional and traditional approaches will become apparent to one of skill in the art, through comparison of such systems with some aspects of the present disclosure as set forth in the remainder of the present application with reference to the drawings.

### SUMMARY

A system and a method for tracking objects is described substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating tracking of an object in an exemplary multi-camera system, in accordance with an embodiment of the disclosure.

FIG. 2 is a block diagram of an exemplary controlling device for controlling cameras and/or sensors of a multi-camera system, in accordance with an embodiment of the disclosure.

FIGS. 3A, 3B, and 3C illustrate examples of tracking an object using a multi-camera system, in accordance with an embodiment of the disclosure.

FIGS. 4A, 4B, and 4C illustrate examples of tracking two or more objects using a multi-camera system, in accordance with an embodiment of the disclosure.

FIG. 5 is a flow chart illustrating exemplary steps for tracking one or more objects by a controlling device, in accordance with an embodiment of the disclosure.

FIG. 6 is a flow chart illustrating exemplary steps for tracking plurality of objects by a controlling device, in accordance with an embodiment of the disclosure.

### DETAILED DESCRIPTION

Various implementations may be found in a system and/or a method for tracking a plurality of objects. Exemplary aspects of a method for tracking a plurality of objects may include a network that is capable of communicatively coupling a plurality of cameras, a plurality of sensors, and a controlling device. The controlling device may receive metadata associated with the plurality of objects. The metadata identifies the plurality of objects. The controlling device may select a first set of cameras from the plurality of cameras to track the plurality of objects based on the received metadata. The controlling device may enable tracking of the plurality of objects by the selected first set of cameras.

The controlling device may select a second set of cameras from the plurality of cameras for tracking one or more objects of the plurality of objects when the one or more objects move out of a field of view of one or more cameras of the selected first set of cameras. The controlling device may select a sensor from the plurality of sensors based on one or more signals received from the plurality of sensors. A location of the plurality of objects relative to the plurality of cameras may be determined based on the received one or more signals. The controlling device may track the plurality of objects by the selected first set of cameras based on a signal received from the selected sensor. A location of the plurality of objects relative to the selected first set of cameras may be determined based on the signal received from the selected sensor.

The controlling device may control one or more parameters of the selected first set of cameras based on a distance between the plurality of objects to be tracked. The controlling device may crop an image captured by the selected first set of cameras based on a relative position of the plurality of objects with the image.

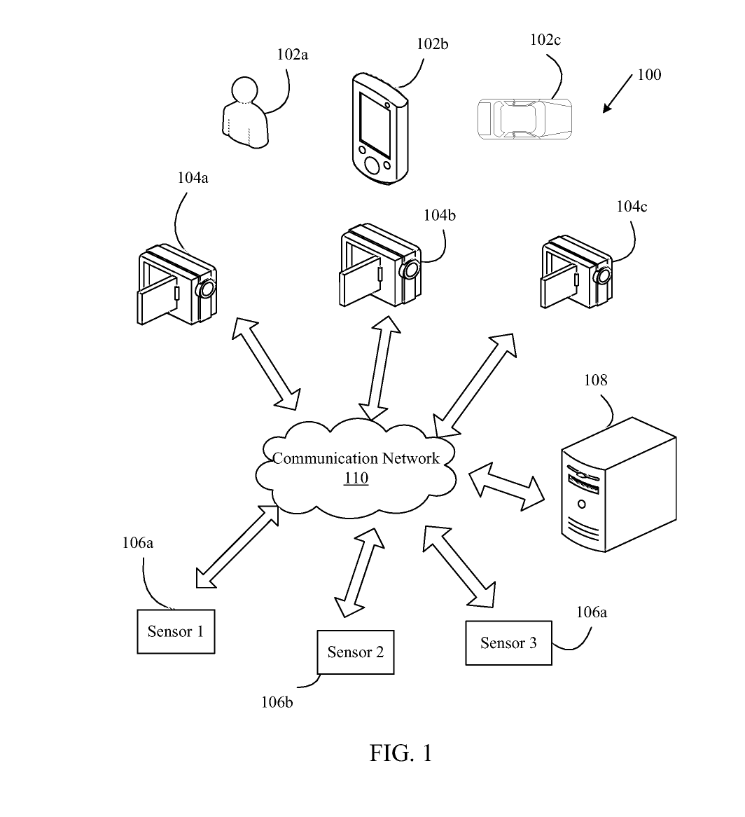

FIG. 1 is a block diagram illustrating tracking of an object in an exemplary multi-camera system, in accordance with an embodiment of the disclosure. With reference to FIG. 1, there is shown a multi-camera system 100. The multi-camera system 100 may track one or more objects, such as a first object 102a, a second object 102b, and a third object 102c (collectively referred to as objects 102). The multi-camera system 100 may comprise a plurality of cameras, such as a first camera 104a, a second camera 104b, and a third camera 104c (collectively referred to as cameras 104). The cameras 104 may track the objects 102. The multi-camera system 100 may further comprise a plurality of sensors, such as a first sensor 106a, a second sensor 106b, and a third sensor 106c (collectively referred to as sensors 106). The multi-camera system 100 may further comprise a controlling device 108 and a communication network 110.

The multi-camera system 100 may correspond to an object tracking system that tracks movement of one or more objects. Examples of the multi-camera system 100 may include, but are not limited to, a security and surveillance system, a system for object recognition, a system for video communication, and/or a system for broadcasting images and/or videos of a live event.

The objects 102 may correspond to any living and/or non-living thing that may be tracked. The objects 102 may correspond to people, animals, articles (such as a ball used in a sport event), an item of inventory, a vehicle, and/or a physical location. For example, the objects 102 may be people visiting a museum. In another example, the objects 102 may correspond to one or more articles in a shop. In an example, the first object 102a may be a player playing a soccer match. In another example, a cell phone of a person may correspond to the second object 102b. In another example, the third object 102c may correspond to vehicles at an entrance of an office building. Notwithstanding, the disclosure may not be so limited and any other living and/or non-living thing may be tracked without limiting the scope of the disclosure.

The cameras 104 may correspond to an electronic device capable of capturing and/or processing an image and/or a video content. The cameras 104 may comprise suitable logic, circuitry, interfaces, and/or code that may be operable to capture and/or process an image and/or a video content. In an embodiment, the cameras 104 may be operable to capture images and/or videos within a visible portion of the electromagnetic spectrum. In another embodiment, the cameras 104 may be operable to capture images and/or videos outside the visible portion of the electromagnetic spectrum. In an embodiment, the cameras 104 may be a pan-tilt-zoom (PTZ) camera. In an embodiment, the pan, tilt, and/or zoom of the cameras 104 may be controlled mechanically. In another embodiment, the pan, tilt, and/or zoom of the cameras 104 may be electronically controlled using solid state components.

In an embodiment, the cameras 104 may be high resolution cameras such as single-lens reflex (SLR) cameras with 20 or more megapixels. A high resolution camera may capture high resolution wide angle images and/or videos. In another embodiment, the cameras 104 may be built from a plurality of smaller-resolution cameras. In an embodiment, the plurality of smaller resolution cameras may be built into a single housing. In another embodiment, the plurality of smaller resolution cameras may be separate. In such a case, output signals of the plurality of smaller resolution cameras may be calibrated. Images and/or videos captured by the plurality of smaller resolution cameras may be combined into a single high-resolution image. In an embodiment, the plurality of smaller resolution cameras may be set up such that the field of view of the plurality of smaller resolution cameras may overlap so that their combined output signal results in a high resolution image.

In an embodiment, the cameras 104 may be installed at one or more locations in the vicinity of an object to be tracked, such as the first object 102a. The cameras 104 may be installed at locations such that the cameras 104 may be able to automatically capture images of the tracked first object 102a. In an embodiment, the cameras 104 may be installed in such a way that a position of each of the cameras 104 is fixed. For example, the cameras 104 may be installed at one or more locations on walls of a room in which the first object 102a is to be tracked. In another example, the cameras 104 may be installed at various locations surrounding a playground.

In another embodiment, one or more of the cameras 104, such as the first camera 104a, may be installed in such a way that a position of the first camera 104a may be changed. In such a case, the position of the cameras 104 may be controlled electronically and/or mechanically. In an embodiment, the first camera 104a may be coupled to a movable article in vicinity of the first object 102a. For example, the first camera 104a may be coupled to a moving aircraft to track one or more objects located below. In another example, the cameras 104 may be mounted on a track or boom. In another example, the cameras 104 may be suspended from cables.

In an embodiment, the cameras 104 may be operable to communicate with the controlling device 108. The cameras 104 may be operable to receive one or more signals from the sensors 106 and the controlling device 108. The cameras 104 may be operable to adjust the pan, tilt, and/or zoom based on the one more signals received from the controlling device 108. The cameras 104 may be operable to transmit one or more signals to the sensors 106 and the controlling device 108.

The sensors 106 may comprise suitable logic, circuitry, interfaces, and/or code that may be operable to determine a location of the objects 102. Examples of the sensors 106 may include, but are not limited to, audio sensors, such as microphones and ultrasonic sensors, position sensors, Radio Frequency Identification (RFID) sensors, and Infra-Red (IR) sensors. Examples of the sensors 106 may further include Bluetooth sensors, Global Positioning System (GPS) sensors, Ultra-Violet (UV) sensors, sensors operable to detect cellular network signals, and/or any sensor operable to determine a location of an object.

In an embodiment, the sensors 106 may be located in the vicinity of the objects 102. For example, when the first object 102a is in a room, a microphone may be installed in the room. In another embodiment, the sensors 106 may be coupled to one or more articles associated with each of the objects 102. For example, a Bluetooth transmitter may be coupled to a belt worn by a security person. In another example, a GPS sensor and/or a Bluetooth transmitter of a cell phone of a person may correspond to the first sensor 106a.

In an embodiment, the sensors 106 may comprise a transmitter and a receiver. For example, the sensors 106 may be a pair of RFID transmitter and receiver. The RFID transmitter may be placed inside a soccer ball used for playing a soccer match. The RFID receiver may be located outside a playground. The RFID receiver may receive the RFID signals transmitted by the RFID transmitter in the ball so that the ball may be tracked during the match. Notwithstanding, the disclosure may not be so limited and any other sensors operable to track objects may be used without limiting the scope of the disclosure.

The sensors 106 may be operable to determine a location of the objects 102 relative to the cameras 104. The sensors 106 may be operable to transmit one or more signals to the controlling device 108. The location of each of the objects 102 may be determined based on the one or more signals. For example, a GPS sensor of a cell phone of a person may be operable to determine a location of the cell phone. The GPS sensor may transmit one or more signals indicating the location of the cell phone to the controlling device 108. In another example, an RFID tag coupled to the clothes of a person may transmit radio frequency (RF) signals to the controlling device 108. In an embodiment, the sensors 106 may be an integrated part of the cameras 104. In another embodiment, the sensors 106 may be located external to the cameras 104 and communicably coupled to cameras 104 via the communication network 110.

The controlling device 108 may comprise suitable logic, circuitry, interfaces, and/or code that may be operable to control the cameras 104 and the sensors 106 to track the objects 102. The controlling device 108 may be operable to receive one or more signals from the cameras 104 and the sensors 106. The controlling device 108 may be operable to process one or more signals received from the sensors 106 to determine a location of the objects 102. The controlling device 108 may determine a direction and a distance of each of the objects 102 relative to the cameras 104. The controlling device 108 may be operable to transmit one or more control signals to the cameras 104 and the sensors 106 to control an operation of the cameras 104 and the sensors 106. In an embodiment, the controlling device 108 may transmit one or more control signals to the cameras 104 based on the determined location of the objects 102. The controlling device 108 may be operable to receive one or more instructions and/or input from a user, such as an operator associated with the controlling device 108. In an embodiment, the controlling device 108 may be operable to receive metadata identifying an object, such as the first object 102a, to be tracked. In an embodiment, the controlling device 108 may receive the metadata from the user associated with the controlling device 108.

The controlling device 108 may be operable to select one or more sensors from the sensors 106 to determine the current location of the first object 102a to be tracked. The controlling device 108 may be further operable to select a first set of cameras from the cameras 104 to track the first object 102a. The controlling device 108 may be operable to control one or more parameters of the cameras 104 based on one or more of: a location of the first object 102a, a direction and a distance of the first object 102a relative to the selected one or more cameras, the first object 102a to be tracked, and/or one or more instructions and/or inputs provided by a user associated with the controlling device 108.

In an embodiment, the controlling device 108 may be an integrated part of a camera, such as the first camera 104a. In another embodiment, the controlling device 108 may be located external to the cameras 104 and communicably coupled to cameras 104 via the communication network 110.

The cameras 104, the sensors 106, and the controlling device 108 may be operable to communicate with each other via the communication network 110. Examples of the communication network 110 may include, but are not limited to, a Bluetooth network, a Wireless Fidelity (Wi-Fi) network, and/or a ZigBee network.

In operation, the multi-camera system 100 may be installed in the vicinity of an area to be monitored and/or an object to be tracked (for example, the first object 102a). The cameras 104 may capture images and/or videos associated with an area to be monitored and/or the first object 102a to be tracked. The cameras 104 may transmit the captured images and/or videos to the controlling device 108. Further, the controlling device 108 may receive one or more signals from the sensors 106. A location of the first object 102a may be determined based on the one or more signals received from the sensors 106.

The controlling device 108 may receive metadata identifying the first object 102a to be tracked. Based on the received metadata, the controlling device 108 may select, in real-time, one or more sensors (such as the first sensor 106a), to determine the current location of the first object 102a to be tracked. The first sensor 106a may determine the current location of the first object 102a to be tracked. The first sensor 106a may determine the location of the first object 102a relative to the cameras 104 of the multi-camera system 100. The first sensor 106a may communicate with the controlling device 108 via the communication network 110. The first sensor 106a may transmit one or more signals to the controlling device 108 via the communication network 110. A location of the first object 102a relative to the cameras 104 may be determined based on the transmitted one or more signals.

Based on the metadata associated with the first object 102a to be tracked, the controlling device 108 may select, in real time, a first set of cameras from the cameras 104 of the multi-camera system 100. The selected first set of cameras may include one or more cameras of the cameras 104. For example, controlling device 108 may select the first camera 104a to track the first object 102a. Based on signals received from the first sensor 106a, the controlling device 108 may control operation of the selected first camera 104a. The controlling device 108 may focus the selected first camera 104a such that the first object 102a lies within the field of view of the selected first camera 104a. When the current position of the first object 102a changes, the selected first camera 104a may track the first object 102a.

In another embodiment, the multi-camera system 100 may be operable to simultaneously track two or more objects, such as the first object 102a and the second object 102b. In such a case, the controlling device 108 may receive metadata identifying the first object 102a and the second object 102b as objects to be tracked. Based on the received metadata, the controlling device 108 may select, in real time, one or more sensors, such as the first sensor 106a. The selected first sensor 106a may determine the current location of the first object 102a and the second object 102b to be tracked. In an embodiment, the first sensor 106a may determine the location of the first object 102a and the second object 102b, relative to the cameras 104 of the multi-camera system 100. The first sensor 106a may communicate with the controlling device 108 via the communication network 110. The first sensor 106a may transmit one or more signals to the controlling device 108 via the communication network 110. A location of the first object 102a and the second object 102b relative to the cameras 104 may be determined based on the transmitted one or more signals.

In an embodiment, based on the metadata associated with the first object 102a and the second object 102b to be tracked, the controlling device 108 may select, in real time, a first set of cameras from the cameras 104 of the multi-camera system 100. The selected first set of cameras may include one or more cameras of the cameras 104. For example, the controlling device 108 may select the first camera 104a to track the first object 102a and the second object 102b. Based on signals received from the first sensor 106a, the controlling device 108 may control operation of the selected first camera 104a. The controlling device 108 may focus the selected first camera 104a such that the first object 102a and the second object 102b lie within the field of view of the selected first camera 104a. When the current position of the first object 102a and/or the second object 102b changes, the selected first camera 104a may track the first object 102a and the second object 102b.

In another embodiment, based on the metadata associated with the first object 102a and the second object 102b to be tracked, the controlling device 108 may select, in real time, two or more cameras. For example, the controlling device 108 may select the first camera 104a and the second camera 104b to track the first object 102a and the second object 102b respectively. Based on signals received from the first sensor 106a, the controlling device 108 may control operation of the selected first camera 104a and the second camera 104b. The controlling device 108 may focus the selected first camera 104a and the second camera 104b such that the first object 102a and the second object 102b lie within the field of view of the selected first camera 104a and the second camera 104b respectively. When the position of the first object 102a and/or the second object 102b changes, the selected first camera 104a and the second camera 104b may track the first object 102a and/or the second object 102b respectively.

In an embodiment, the multi-camera system 100 may be used to track the objects 102 located at large distances from the cameras 104. For example, the multi-camera system 100 may be installed in an aircraft to track people located on the ground. In another example, the multi-camera system 100 may be used to monitor a large valley from a mountain top.

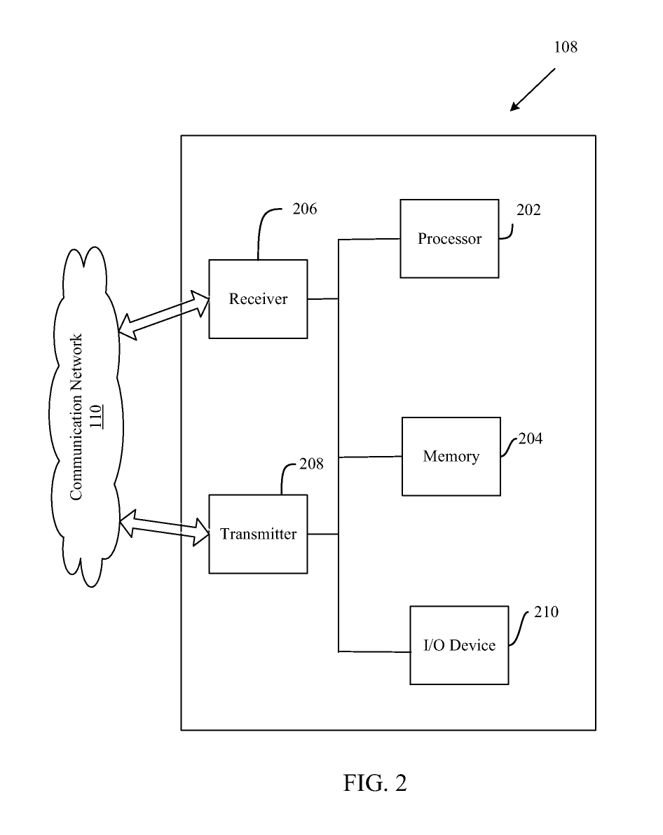

FIG. 2 is a block diagram of an exemplary controlling device for controlling cameras and/or sensors of a multi-camera system, in accordance with an embodiment of the disclosure. The block diagram of FIG. 2 is described in conjunction with elements of FIG. 1.

With reference to FIG. 2, there is shown the controlling device 108. The controlling device 108 may comprise one or more processors, such as a processor 202, a memory 204, a receiver 206, a transmitter 208, and an input/output (I/O) device 210.

The processor 202 may be communicatively coupled to the memory 204, and the I/O device 210. The receiver 206 and the transmitter 208 may be communicatively coupled to the processor 202, the memory 204, and the I/O device 210.

The processor 202 may comprise suitable logic, circuitry, and/or interfaces that may be operable to execute at least one code section stored in the memory 204. The processor 202 may be implemented based on a number of processor technologies known in the art. Examples of the processor 202 may include, but are not limited to, an X86-based processor, a Reduced Instruction Set Computing (RISC) processor, an Application-Specific Integrated Circuit (ASIC) processor, and/or a Complex Instruction Set Computer (CISC) processor.

The memory 204 may comprise suitable logic, circuitry, interfaces, and/or code that may be operable to store a machine code and/or a computer program having at least one code section executable by the processor 202. Examples of implementation of the memory 204 may include, but are not limited to, Random Access Memory (RAM), Read Only Memory (ROM), Hard Disk Drive (HDD), and/or a Secure Digital (SD) card. The memory 204 may be operable to store data, such as configuration settings of the cameras 104 and the sensors 106. The memory 204 may further be operable to store data associated with the objects 102 to be tracked. Examples of such data associated with the objects 102 may include, but are not limited to, metadata associated with the objects 102, locations of the objects 102, preference associated with the objects 102, and/or any other information associated with the objects 102.

The memory 204 may further store one or more images and/or video content captured by the cameras 104, one or more image processing algorithms, and/or any other data. The memory 204 may store one or more images and/or video contents in various standardized formats such as Joint Photographic Experts Group (JPEG), Tagged Image File Format (TIFF), Graphics Interchange Format (GIF), and/or any other format.

The receiver 206 may comprise suitable logic, circuitry, interfaces, and/or code that may be operable to receive data and messages. The receiver 206 may receive data in accordance with various known communication protocols. In an embodiment, the receiver 206 may receive one or more signals transmitted by the sensors 106. In another embodiment, the receiver 206 may receive one or more signals transmitted by the cameras 104. In another embodiment, the receiver 206 may receive data from the cameras 104. Such data may include one or more images and/or videos associated with the objects 102 captured by the cameras 104. The receiver 206 may implement known technologies for supporting wired or wireless communication between the controlling device 108, and the cameras 104 and/or the sensors 106.

The transmitter 208 may comprise suitable logic, circuitry, interfaces, and/or code that may be operable to transmit data and/or messages. The transmitter 208 may transmit data, in accordance with various known communication protocols. In an embodiment, the transmitter 208 may transmit one or more control signals to the cameras 104 and the sensors 106 to control an operation thereof.

The I/O device 210 may comprise various input and output devices that may be operably coupled to the processor 202. The I/O device 210 may comprise suitable logic, circuitry, interfaces, and/or code that may be operable to receive input from a user operating the controlling device 108 and provide an output. Examples of input devices may include, but are not limited to, a keypad, a stylus, and/or a touch screen. Examples of output devices may include, but are not limited to, a display and/or a speaker.

In operation, the processor 202 may communicate with the cameras 104 and the sensors 106 via the communication network 110. The processor 202 may further receive data, such as images and/or videos, from the cameras 104. The processor 202 may store the data received from the cameras 104 and the sensors 106 in the memory 204. The processor 202 may receive metadata identifying one or more objects to be tracked. Based on the received metadata that identifies the one or more objects to be tracked, the processor 202 may select a first set of cameras from the multi-camera system 100 to track the one or more objects. In response to the received metadata, the processor 202 may select, in real time, a first set of cameras to track the one or more objects without any additional input. The processor 202 may track the one or more objects using the selected first set of cameras.

In an embodiment, the processor 202 may be operable to control the multi-camera system 100 to track an object, such as the first object 102a. The first object 102a to be tracked may be identified based on metadata associated with the first object 102a. Examples of the metadata associated with an object to be tracked may include, but are not limited to, a name of an object to be tracked, an image of an object to be tracked, a unique identifier associated with a object to be tracked, a face print of an object to be tracked, an audio-visual identifier associated with an object to be tracked, a sound associated with an object to tracked, and/or any other information capable of identifying an object to be tracked. For example, the color of a dress worn by a person may correspond to metadata that identifies the person to be tracked. In another example, a noisiest object in an area may correspond to an object to be tracked.

In an embodiment, the processor 202 may receive the metadata from a user associated with the controlling device 108. In an embodiment, the processor 202 may prompt a user to enter metadata identifying the first object 102a to be tracked. In an embodiment, a user may enter the metadata via the I/O device 210. For example, a user may enter name of a person to be tracked via a keyboard.

In another embodiment, a user may specify the first object 102a to be tracked from images and/or videos captured by the cameras 104. For example, a user may specify a person to be tracked by the cameras 104 by touching the face of the corresponding person in an image captured by the cameras 104. In another example, a user may select a ball as the first object 102a to be tracked by clicking on the corresponding ball in an image captured by the cameras 104. In another embodiment, a user may enter metadata identifying the first object 102a to be tracked via speech input. Notwithstanding, the disclosure may not be so limited and any other method for providing metadata associated with an object to be tracked may be used without limiting the scope of the disclosure.

The receiver 206 may receive one or more signals from the sensors 106. A current location of the first object 102a to be tracked may be determined based on the one or more signals received from the sensors 106. Further, the processor 202 may process the received one or more signals to determine the current location of the first object 102a. The processor 202 may be operable to process the received one or more signals to determine a direction and a distance of the first object 102a relative to the cameras 104. In an embodiment, the processor 202 may determine the direction and the distance of the first object 102a relative to the cameras 104 based on a triangulation method. The processor 202 may also be operable to process the received one or more signals to determine one or more activities being performed by the first object 102a. For example, based on received GPS signals, the processor 202 may determine whether a tracked person is moving up or down a staircase. The processor 202 may store the determined current location, activities performed, and/or the direction and/or the distance of the first object 102a relative to the cameras 104 in the memory 204.

The processor 202 may be operable to select a sensor, such as the first sensor 106a, from the sensors 106 based on the one or more signals received from the sensors 106 and the first object 102a to be tracked. For example, the first object 102a may be a ball in which an RFID tag is embedded. In such a case, the processor 202 may select an RFID sensor to receive one or more signals. In another example, the first object 102a may be a person with a cell phone. In such a case, the processor 202 may select a GPS sensor to receive one or more signals. Further, the processor 202 may select sensing of cell phone signals to determine a location of the person carrying the cell phone.

In an embodiment, the processor 202 may select the first sensor 106a based on a current location of the first object 102a to be tracked. For example, an IR sensor requires the first object 102a to be in the line of sight for operation. Thus, the processor 202 may select an IR sensor when a current location of the first object 102a is such that the first object 102a lies in the line of sight of the IR sensor.

In an embodiment, the processor 202 may select the first sensor 106a from the sensors 106 based on a range of the sensors 106 and distance of the first object 102a to be tracked from the sensors 106. For example, a Bluetooth sensor and an IR sensor are short range sensors that are capable of sensing an object within a pre-determined distance from such sensors. Thus, the processor 202 may select such sensors only when the first object 102a lies within the pre-determined distance range of such sensors. In another example, a GPS sensor and a cell phone network-based sensor are long range sensors that are capable of sensing an object located far away from such sensors. Thus, the processor 202 may select such sensors when the first object 102a lies outside the pre-determined distance range of other short range sensors.

In an embodiment, the processor 202 may select two or more sensors, such as the first sensor 106a and the second sensor 106b. For example, the first object 102a may be an actor performing on a stage. A Bluetooth transmitter may be coupled to a tie worn by the actor. In such a case, the processor 202 may select a microphone and a Bluetooth receiver to receive one or more signals. In an embodiment, the processor 202 may dynamically switch between the first sensor 106a and the second sensor 106b to determine a location of the first object 102a.

In an embodiment, based on the received metadata, the processor 202 may select, in real time, the first camera 104a such that the selected first camera 104a is capable of capturing an image of the first object 102a. In an embodiment, the processor 202 may select the first camera 104a such that the first camera 104a satisfies one or more pre-determined criteria. Examples of such pre-determined criteria may include, but are not limited to: an angle from which image of the first object 102a may be captured, the quality of image of the first object 102a, a distance of the first object 102a from the first camera 104a, the field of view of the first camera 104a, and/or a degree of zoom, pan, and/or tilt required by the first camera 104a to capture image of the first object 102a. In an example, the processor 202 may select the first camera 104a such that the first camera 104a is closest to the location of the first object 102a. In another example, the processor 202 may select the first camera 104a such that the first object 102a lies in the field of view of the first camera 104a. In another example, the processor 202 may select the first camera 104a such that the first camera 104a may capture a front image of the first object 102a.

In an embodiment, two or more cameras may satisfy the pre-determined criteria. In such a case, a user associated with the controlling device 108 may specify a camera to be selected from the two or more cameras. Further, the processor 202 may be operable to select a camera from the two or more cameras based on a pre-defined priority order associated with the two or more cameras. In another embodiment, none of the cameras 104 may satisfy the pre-determined criteria. In such a case, the processor 202 may select a default camera to track the first object 102a.

In an embodiment, the processor 202 may be operable to dynamically control one or more parameters of the selected first camera 104a based on one or more signals received from the selected first sensor 106a. The processor 202 may control one or more parameters of the selected first camera 104a based on a direction and a distance of the first object 102a relative to the selected first camera 104a and/or the first object 102a to be tracked. Examples of the one or more parameters may include, but are not limited to, position, zoom, tilt, and/or pan of a camera. For example, when the first object 102a moves out of the field of view of the selected first camera 104a, the processor 202 may adjust the pan, zoom, and/or tilt of the selected first camera 104a such that the first object 102a may remain in the field of view of the selected first camera 104a. In an embodiment, the processor 202 may adjust the pan, zoom, and/or tilt of the selected first camera 104a based on a direction and a distance of the first object 102a relative to the selected first camera 104a.

In an embodiment, the processor 202 may track the first object 102a by using the selected first camera 104a based on one or more signals received from the selected first sensor 106a. A direction and/or a distance of the first object 102a relative to the selected first camera 104a may be determined based on the one or more signals received from the selected first sensor 106a. In an embodiment, a current direction and a distance of the first object 102a relative to the selected first camera 104a may also change. The processor 202 may determine the change in location of the first object 102a relative to the selected first camera 104a based on the one or more signals received from the selected first sensor 106a. In an embodiment, the processor 202 may select a second set of cameras to track the first object 102a. The second set of cameras may include one or more cameras. For example, the processor 202 may select the second camera 104b, to track the first object 102a. In an embodiment, the processor 202 may select the second set of cameras based on the determined change in location of the first object 102a. In another embodiment, the processor 202 may be operable to switch between multiple cameras based on the change in location of the first object 102a. For example, when the location of the first object 102a changes, the first object 102a may move out of the field of view of the selected first camera 104a. In such a case, the processor 202 may select the second camera 104b. The processor 202 may track the first object 102a using the second camera 104b. In an embodiment, the processor 202 may select the second camera 104b based on the metadata associated with the first object 102a. In another embodiment, the processor 202 may select the second camera 104b based on the one or more signals received from the selected first sensor 106a.

In another example, when the location of the first object 102a changes, the first object 102a may move away from the selected first camera 104a such that the first object 102a may be closer to another camera. In such a case, the processor 202 may determine which camera is closest to the first object 102a. The determination may be based on the metadata associated with the first object 102a and one or more signals received from the selected first sensor 106a. The processor 202 may select a camera, such as the second camera 104b, closest to the first object 102a. The processor 202 may track the first object 102a using the selected second camera 104b. When the first object 102a again moves closer to the first camera 104a, the processor 202 may switch again to the first camera 104a to track the first object 102a.

In an embodiment, the processor 202 may be operable to coordinate between multiple cameras of the multi-camera system 100. In an embodiment, the processor 202 may coordinate the adjustment of one or more parameters and/or settings of the multiple cameras. For example, the processor 202 may adjust the tilt of the first camera 104a, the second camera 104b, and the third camera 104c such that each of the first camera 104a, the second camera 104b, and the third camera 104c may capture images and/or videos of a particular area in a room.

In another embodiment, the processor 202 may be operable to control the position of a movable camera of the multi-camera system 100. For example, the first camera 104a may be installed in such a way that the position of the first camera 104a, relative to the first object 102a, may be changed. The processor 202 may move the first camera 104a from a first position to a second position based on a location of the first object 102a to be tracked. For example, the first camera 104a may be coupled to an aircraft to monitor people inside a building. In such a case, the position of the first camera 104a may be changed when the aircraft moves. The processor 202 may control the movement of the aircraft such that the first camera 104a may be able to capture images of the people inside the building. For example, when the first camera 104a is not able to capture images from one side of the building, the processor 202 may control the aircraft to move to another side of the building.

In an embodiment, a user associated with the controlling device 108 may provide metadata associated with an object that is not visible in images and/or videos captured by any of the cameras 104 of the multi-camera system 100. For example, the multi-camera system 100 may track people inside a museum. The user may specify the name of a person to be tracked. The person to be tracked may not be visible in images and/or videos captured by any of the cameras 104 of the multi-camera system 100. In such a case, the processor 202 may determine, in real time, the current location of the person to be tracked based on one or more signals received from the sensors 106, such as a GPS sensor. Based on the determined current location, the processor 202 may select a camera capable of capturing images and/or videos of the person to be tracked. For example, based on the determined current location, the processor 202 may select a camera of the multi-camera system 100 that is closest to the current location of the person to be tracked.

In another example, the processor 202 may adjust the pan, tilt and/or zoom of the cameras 104 based on the current location of the person to be tracked such that the person to be tracked may lie in the field of view of at least one of the cameras 104.

In an embodiment, the selected first sensor 106a may correspond to a microphone. The microphone may detect the location of the first object 102a based on sound associated with the first object 102a. The microphone may transmit one or more audio signals to the processor 202. The processor 202 may determine a location of the first object 102a, relative to the cameras 104, based on the one or more audio signals received from the microphone. In an embodiment, the processor 202 may use at least three microphones to determine the location of the source of a sound using a triangulation method.

In another embodiment, the processor 202 may apply various types of filters to the one or more audio signals received from the microphone to remove noise. Filtering may be applied to the one or more audio signals received from the microphones to filter out sounds that are not associated with the first object 102a being tracked. In an embodiment, the processor 202 may apply filters on the microphone such that the microphone may only respond to pre-determined sounds. Examples of such pre-determined sounds may include, but are not limited to, sounds within a given frequency range, sounds that have a particular pattern of amplitude, sounds that are associated with a certain shape of generated waveform, sounds that are associated with particular harmonics, sounds that include presence of human speech, sounds based on voice recognition, and/or trigger sounds. Such trigger sounds may be a telephone ring tone and/or a distinctive sound made by a machine when it performs a certain action (such as sounds of a car engine starting and/or a dog barking). In an embodiment, the processor 202 may synchronize characteristics of a sound detected by a microphone with characteristics of a video frame in which the sound was generated for filtering or triggering.

In an embodiment, the multi-camera system 100 may include omni-directional microphones and directional microphones. The omni-directional microphones may detect ambient noise around the first object 102a. Based on audio signals received from the omni-directional microphones, the processor 202 may process audio signals received from the directional microphones to remove noise.

In an embodiment, the multi-camera system 100 that may use a microphone as the selected first sensor 106a may be implemented such that the object producing the most noise in a monitored area may be automatically selected as an object to be tracked. For example, when an actor (such as a first actor) on a stage is talking, a microphone may detect sound coming from the first actor. Based on the sound detected by the microphone, the processor 202 may select the first actor as an object to be tracked. The processor 202 may select one or more cameras to track the first actor across the stage. When another actor (such as a second actor) speaks, the microphone may detect sound coming from the second actor. Based on the sound detected by the microphone, the processor 202 may select the second actor as an object to be tracked. The processor 202 may select one or more cameras to track the first actor across the stage. When multiple actors (such as both the first actor and the second actor) speak, the microphone may detect sound coming from both the first actor and the second actor. Based on the sound detected by the microphone, the processor 202 may select both the first actor and the second actor as objects to be tracked. The processor 202 may select one or more cameras to track the first actor and the second actor across the stage.

In an embodiment, the multi-camera system 100 that utilizes a microphone as the selected first sensor 106a in a system where there is normally not much sound. In such a system, when something may make a sound, the source of that sound may be automatically selected as an object to be tracked. For example, the multi-camera system 100 may be installed in a clearing in woods. When a wolf howls, a microphone may detect the howling sound coming from the wolf. The processor 202 may select the wolf as an object to be tracked. The processor 202 may determine the location of the wolf based on the howling sound detected by the microphone. The processor 202 may select a camera to track the wolf. The processor 202 may zoom the selected camera on the wolf.

In an embodiment, the multi-camera system 100 may further include one or more cameras (referred to as non-visible cameras) that may be capable to detect radiations lying in a non-visible part of the electromagnetic spectrum. Such non-vision cameras may be in addition to the cameras 104 that are capable of capturing images and/or videos within a visible portion of the electromagnetic spectrum. Examples of such radiations lying in a non-visible part of the electromagnetic spectrum may include, but are not limited to, UV and IR radiations. Examples of such non-visible cameras may be a UV camera and/or an IR camera. In an embodiment, a non-visible camera may be integrated with the cameras 104. The processor 202 may determine a correlation between images captured by the cameras 104 and images captured by the non-visible cameras.

The processor 202 may determine the location and distance of an object to be tracked relative to the cameras 104 based on one or more signals provided by the non-visible cameras. In an embodiment, the multi-camera system 100 may use multiple non-visible cameras to determine the location and distance of an object to be tracked relative to the cameras 104. In an embodiment, the multi-camera system 100 may use a triangulation method to determine the location and distance. In another embodiment, the processor 202 may apply three-dimensional (3D) processing to the output of the non-visible cameras to determine the locations and distances of an object to be tracked.

In an embodiment, a non-visible camera may include a special frequency laser to illuminate an object to be tracked with light outside visible spectrum. The special frequency laser may be used to tag an object to be tracked. A non-visible camera may determine an object to be tracked based on illumination by the laser.

In an embodiment, the multi-camera system 100, which has a non-visible camera, may be used to track an object in locations where light in the visible spectrum is not enough to detect the object to be tracked visually. In such low visible light conditions, the processor 202 may determine the location of the object to be tracked based on a transmitter in IR or UV range carried by the object. The processor 202 may control the flash of the cameras 104 to capture images of the object to be tracked.

In an embodiment, the multi-camera system 100, which has an IR camera, may be used to track one or more objects that are in a particular temperature range. For example, by using IR cameras, a person may be tracked based on human body temperature.

Although the disclosure relates to a single camera that may track an object, one skilled in the art may appreciate that the disclosure can be implemented for any number of cameras that may track an object. For example, the first object 102a may be tracked simultaneously by the first camera 104a and the second camera 104b selected by the processor 202.

Although the disclosure describes tracking a single object using the multi-camera system 100, one skilled in the art may appreciate that the disclosure can be implemented for any number of objects to be tracked. For example, the multi-camera system 100 may track a plurality of objects simultaneously.

In an embodiment, the processor 202 may be operable to control the multi-camera system 100 to simultaneously track two or more objects, such as the first object 102a and the second object 102b. The processor 202 may receive metadata identifying the first object 102a and the second object 102b to be tracked. Based on the metadata received for the first object 102a and the second object 102b, the processor 202 may be operable to select, in real-time, one or more cameras to track the first object 102a and the second object 102b.

For example, the processor 202 may select a single camera, such as the first camera 104a, to track the first object 102a and the second object 102b simultaneously. In an embodiment, the processor 202 may select the first camera 104a such that both the first object 102a and the second object 102b lie in the field of view of the selected first camera 104a. In an embodiment, the processor 202 may control the zoom, tilt, and/or pan of the selected first camera 104a such that both the first object 102a and the second object 102b lie in field of view of the selected first camera 104a. In an embodiment, the processor 202 may adjust the pan, zoom, and/or tilt of the selected first camera 104a based on a direction and/or a distance of each of the first object 102a and the second object 102b, relative to the selected first camera 104a. In another embodiment, the processor 202 may adjust the pan, zoom, and/or tilt of the selected first camera 104a based on a direction and/or a distance of the first object 102a, relative to the second object 102b. For example, both the first object 102a and the second object 102b move in the same direction. In such a case, the processor 202 may zoom the selected first camera 104a to the extent that both the first object 102a and the second object 102b lie in field of view of the first camera 104a. In another example, the first object 102a and the second object 102b move in an opposite direction. In such a case, the processor 202 may zoom out the selected first camera 104a, such that both the first object 102a and the second object 102b remain in field of view of the first camera 104a.

In an embodiment, the first object 102a and the second object 102b may be at such a distance that both the first object 102a and the second object 102b may never be in the field of view of the first camera 104a. In such a case, the processor 202 may select two different cameras, such as the first camera 104a and the second camera 104b, to individually track the first object 102a and the second object 102b, respectively. The processor 202 may control the first camera 104a and the second camera 104b independently to track the first object 102a and the second object 102b.

In an embodiment, the processor 202 may be operable to dynamically control one or more operations and/or settings of one or more devices external to the multi-camera system 100. The one or more external devices may be associated with the one or more objects to be tracked. In an embodiment, the one or more external devices may be located within a pre-determined proximity of the one or more objects to be tracked. The processor 202 may dynamically control such external devices based on one or more of: the location of one or more tracked objects relative to such external devices, settings required by the selected first set of cameras that may track one or more objects, and/or preference of a user associated with the controlling device 108. Additionally, the processor 202 may dynamically control such external devices based on characteristics, such as color and size, of the one or more tracked objects. In an embodiment, the processor 202 may dynamically control external devices based on input provided by a user associated with the controlling device 108. In another embodiment, the processor 202 may dynamically control the external devices based on one or more instructions stored in the memory 204.

In an embodiment, the processor 202 may dynamically control lighting in an area in which the first object 102a is to be tracked. For example, the processor 202 may increase lighting in a room when a tracked person enters the room. This may help the person to clearly see various things placed in the room. Also, a user associated with the controlling device 108 may be able to see the tracked person. In another example, when a tracked person moves closer to a street light, the processor 202 may increase brightness of the street light so that visibility of the person is improved.

In an embodiment, images and/or videos of one or more objects being tracked by the selected first set of cameras may be displayed on a display screen to a user associated with the controlling device 108. In an embodiment, the display screen may correspond to the display of the controlling device 108. In another embodiment, the images and/or videos may be displayed on a display screen external to the controlling device 108. In an embodiment, the images and/or videos may be displayed based on one or more criteria pre-specified by the user associated with the controlling device 108. For example, an image and/or video may be displayed only when one or more objects specified by the user are visible in the image and/or video. In an embodiment, the processor 202 may display one or more default images when images and/or videos that satisfy the user specified one or more criteria are not available.

In an embodiment, the controlling device 108 may store information associated with one or more tracked objects in the memory 204. Examples of such information may include, but are not limited to, a time at which the one or more objects are seen in an image captured by the cameras 104 and a duration for which the one or more objects are seen in an image captured by the cameras 104.

In an embodiment, the cameras 104 may be high resolution cameras that capture high resolution wide angle images and/or videos. In such a case, the processor 202 may be operable to crop an image and/or video signal from the high resolution wide angle images and/or videos captured by the high resolution cameras (referred to as high resolution signal). For example, the cameras 104 may be SLR cameras with 20 or more megapixels. The processor 202 may crop high resolution signals of the SLR cameras such that a normal 1080 p or 720 p signal may be cropped out of the high resolution signal.

In an embodiment, the processor 202 may crop the high resolution signal based on a position of an object to be tracked in the high resolution signal. In another embodiment, the processor 202 may select a portion of a high resolution signal to crop based on relative positions of one or more tracked objects within the high resolution signal. For example, the processor 202 may crop a portion of a high resolution signal that includes an object to be tracked. The controlling device 108 may track an object based on the cropped portion. In an embodiment, a high resolution signal obtained from high resolution cameras may be stored in the memory 204. The stored high resolution signal may be used to monitor other objects and/or areas included in the high resolution signal.

In an embodiment, the processor 202 may zoom-in and/or zoom-out cropped portions of a high resolution signal to obtain a desired viewing resolution. For example, an image portion cropped out of a high resolution signal may be zoomed into a portion of the field of view of the cameras 104.

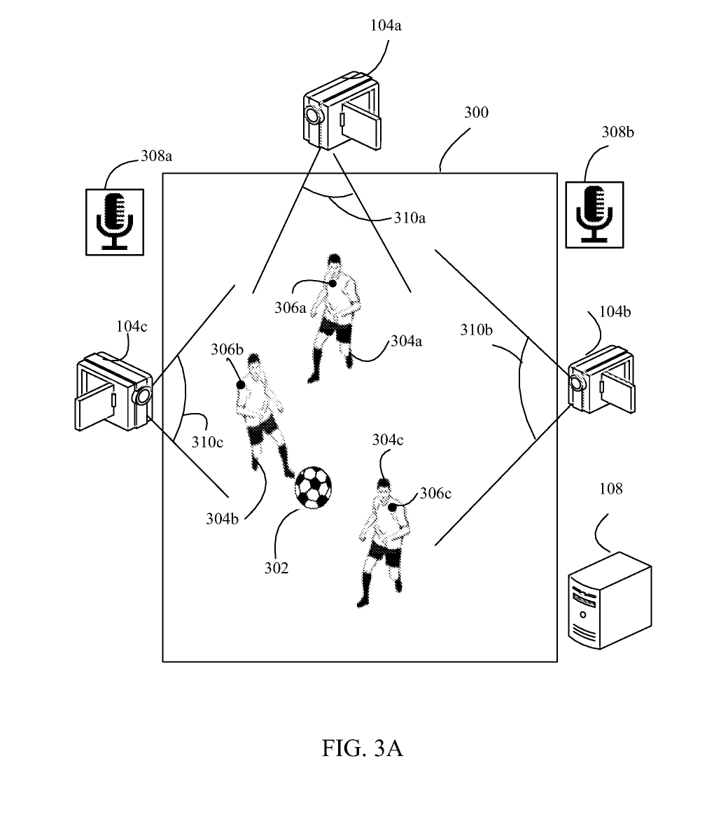

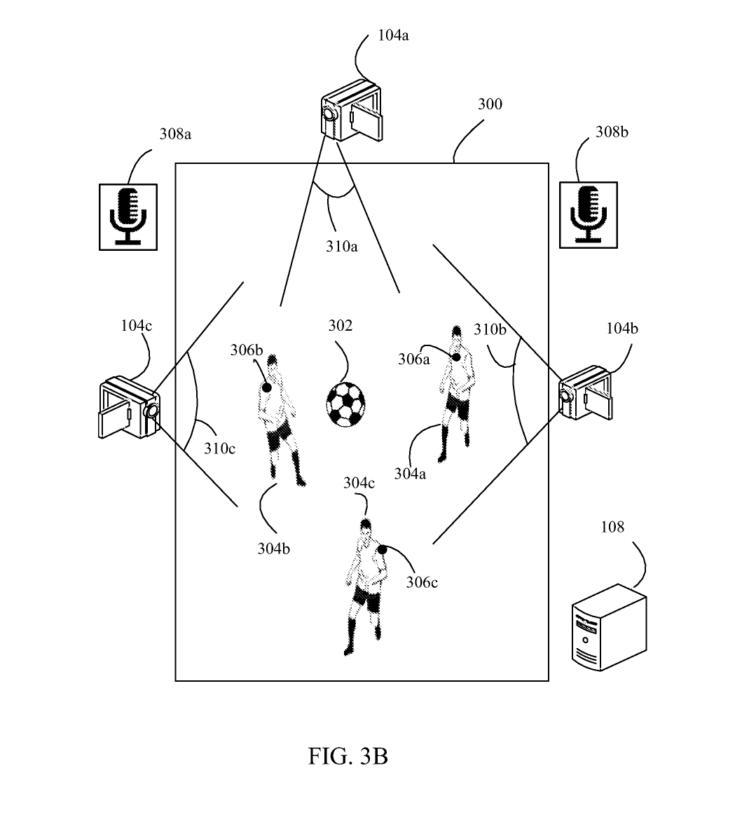

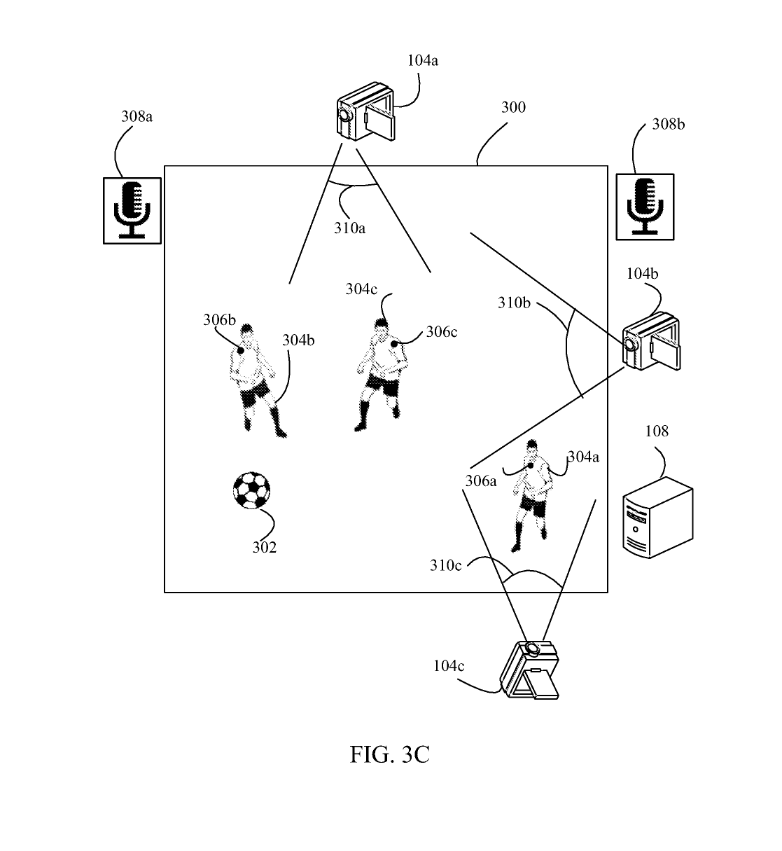

FIGS. 3A, 3B, and 3C illustrate examples of tracking an object based on a multi-camera system, in accordance with an embodiment of the disclosure. The examples of FIGS. 3A, 3B, and 3C are explained in conjunction with the elements from FIG. 1 and FIG. 2.

With reference to FIGS. 3A, 3B, and 3C, there is shown a soccer field 300, a soccer ball 302, and one or more players, such as a first player 304a, a second player 304b, and a third player 304c (collectively referred to as players 304). The soccer ball 302 and the players 304 may correspond to the objects 102 to be tracked. Notwithstanding, the disclosure may not be so limited and any objects on the soccer field 300 may be tracked without limiting the scope of the disclosure.

FIGS. 3A, 3B, and 3C further show one or more sensors, such as a first GPS sensor 306a, a second GPS sensor 306b, a third GPS sensor 306c (collectively referred to as GPS sensors 306). FIGS. 3A, 3B, and 3C further show one or more microphones, such as a first microphone 308a and a second microphone 308b (collectively referred to as microphones 308). Notwithstanding, the disclosure may not be so limited and any other type of sensors operable to track objects may be used without limiting the scope of the disclosure. The first GPS sensor 306a, the second GPS sensor 306b, and the third GPS sensor 306c may be coupled to collars of the shirts worn by the first player 304a, the second player 304b, and the third player 304c, respectively. The microphones 308 may be installed external to the soccer field 300. For example, the first microphone 308a may be installed on a pillar at the boundary of the soccer field 300. In an embodiment, a Bluetooth sensor (not shown in FIGS. 3A, 3B, and 3C) may be embedded inside the soccer ball 302. Notwithstanding, the disclosure may not be so limited and sensors may be located at any other places in the vicinity of the soccer field 300 without limiting the scope of the disclosure.

FIGS. 3A, 3B, and 3C further show the controlling device 108 and one or more cameras, such as the first camera 104a, the second camera 104b, and the third camera 104c, which have already been described in detail in FIG. 1. FIGS. 3A, 3B, and 3C further illustrate a first field of view 310a of the first camera 104a, a second field of view 310b of the second camera 104b, and a third field of view 310c of the third camera 104c.

The first camera 104a, the second camera 104b, and the third camera 104c may be installed at different locations surrounding the soccer field 300 such that the soccer field 300 lies in the field of view of each of the first camera 104a, the second camera 104b, and the third camera 104c. In an embodiment, the third camera 104c may be installed in such a way that the position of the third camera 104c may be changed. For example, the third camera 104c may be a hand-held camera and/or may be mounted on a movable trolley. Notwithstanding, the disclosure may not be so limited and cameras may be located at any other places in the vicinity of the soccer field 300 without limiting the scope of the disclosure.

The cameras 104, the first GPS sensor 306a, the second GPS sensor 306b, the third GPS sensor 306c, the first microphone 308a, the second microphone 308b, and the Bluetooth sensor may communicate with the controlling device 108 via the communication network 110 (not shown in FIGS. 3A, 3B, and 3C). The first GPS sensor 306a, the second GPS sensor 306b, the third GPS sensor 306c, the first microphone 308a, the second microphone 308b, and the Bluetooth sensor may transmit one or more signals to the controlling device 108 via the communication network 110. A location of the soccer ball 302 and the players 304 relative to the cameras 104 may be determined based on the one or more signals transmitted by the first GPS sensor 306a, the second GPS sensor 306b, the third GPS sensor 306c, the first microphone 308a, the second microphone 308b, and the Bluetooth sensor. The cameras 104 may capture images and/or videos of the soccer ball 302 and the players 304. The captured images and/or videos may be transmitted to the controlling device 108 via the communication network 110.

The controlling device 108 may receive metadata identifying an object to be tracked. In an embodiment, a user associated with the controlling device 108 may specify a particular player to be tracked. The user may specify the particular player by entering a name of the player via a keyboard and/or by selecting the player in an image captured by the cameras 104.

For example, the user may enter a name of the first player 304a to specify the first player 304a as an object to be tracked. Based on the entered name of the first player 304a, the controlling device 108 may determine a current location of the first player 304a relative to the cameras 104. The controlling device 108 may determine the current location of the first player 304a based on the one or more signals transmitted by the first GPS sensor 306a, the second GPS sensor 306b, the third GPS sensor 306c, the first microphone 308a, the second microphone 308b, and the Bluetooth sensor. Based on the first player 304a, the controlling device 108 may select a sensor capable of identifying the current location of the first player 304a. For example, the controlling device 108 may select the first GPS sensor 306a to determine a location of the first player 304a. In another example, when the controlling device 108 is unable to receive the one or more signals from the first GPS sensor 306a, the controlling device 108 may select the first microphone 308a to determine a location of the first player 304a.

FIG. 3A illustrates that the first player 304a may be currently located at a first location. Based on the current location of the first player 304a, the controlling device 108 may select a camera to track the first player 304a. For example, the controlling device 108 may select the first camera 104a that may be closest to the current location of the first player 304a. When the first player 304a may move across the soccer field 300, the first camera 104a may track the first player 304a.

When the first player 304a moves across the soccer field 300, the controlling device 108 may adjust the pan, zoom, and/or tilt of the first camera 104a such that the first player 304a lies within the first field of view 310a of the first camera 104a. When the first player 304a moves out of the first field of view 310a of the first camera 104a, the controlling device 108 may select another camera to track the first player 304a.

FIG. 3B illustrates that the first player 304a may move to a second location on the soccer field 300. The second location of the first player 304a may be such that the first player 304a is out of the first field of view 310a of the first camera 104a. In such a case, the controlling device 108 may select another camera closer to the second location of the first player 304a. For example, the controlling device 108 may select the second camera 104b such that the first player 304a may lie in the second field of view 310b of the second camera 104b. When the first player 304a again moves closer to the first camera 104a, the controlling device 108 may switch again to the first camera 104a to track the first player 304a.

In an embodiment, the first player 304a may not lie in the field of view of any of the first camera 104a, the second camera 104b, and the third camera 104c. In such a case, the controlling device 108 may change the position of the movable camera. For example, the controlling device 108 may move the third camera 104c to another location.

FIG. 3C illustrates that the third camera 104c may be moved from a first position (shown in FIG. 3A) to a second position such that the first player 304a lies in the third field of view 310c of the third camera 104c. In an embodiment, the controlling device 108 may change position of the third camera 104c, in real time, based on the change in location of the first player 304a. Although the disclosure describes using a single camera to track an object, one skilled in the art may appreciate that the disclosure can be implemented for tracking an object by any number of cameras. For example, both the first camera 104a and the second camera 104b may simultaneously track the first player 304a.

In another example, metadata identifying an object to be tracked may comprise any player who possesses the soccer ball 302. Based on the metadata, the controlling device 108 may select the Bluetooth sensor embedded in the soccer ball 302 to determine a current location of the soccer ball 302. The controlling device 108 may receive one or more Bluetooth signals from the Bluetooth sensor. The controlling device 108 may determine the current location of the soccer ball 302 based on the received one or more Bluetooth signals. Based on the determined current location of the soccer ball 302, the controlling device 108 may determine which player currently possesses the soccer ball 302. The controlling device 108 may compare one or more GPS signals received from the GPS sensors 306 coupled to each of the players 304 with the one or more Bluetooth signals received from the Bluetooth sensor. Based on the comparison, the controlling device 108 may determine a GPS sensor which matches the current location of the soccer ball 302 specified by the Bluetooth sensor. A player associated with such a GPS sensor (such as the first player 304a) may correspond to the player that currently possesses the soccer ball 302. Based on the current location of the first player 304a, the controlling device 108 may select a camera (such as the first camera 104a) to track the first player 304a. As long as the first player 304a possesses the soccer ball 302, the controlling device 108 may track the first player 304a by the first camera 104a. Whenever the soccer ball 302 is transferred from one player to another, the controlling device 108 may determine which player possesses the soccer ball 302 and may track that player. In another embodiment, the controlling device 108 may only track the soccer ball 302 without tracking the player who possesses the soccer ball 302.

In an embodiment, images and/or videos of the soccer ball 302, the players 304, and/or any other object on the soccer field 300 may be displayed to a user associated with the controlling device 108. The images and/or videos may be displayed on a display of the controlling device 108 and/or any display screen external to the controlling device 108. In an embodiment, the controlling device 108 may display only the images and/or videos associated with the tracked first player 304a. When none of the cameras are able to capture images and/or videos of the first player 304a, the controlling device 108 may not display any image and/or video. Alternatively, the controlling device 108 may display a default image and/or video. Notwithstanding, the disclosure may not be so limited and any number of players and/or objects on the soccer field 300 may be tracked without limiting the scope of the disclosure.

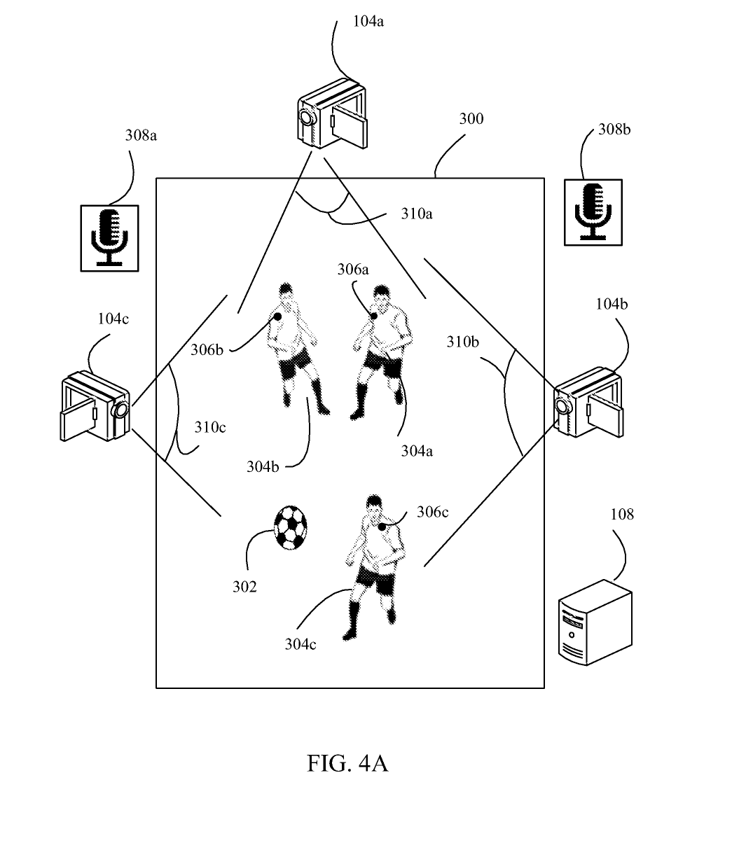

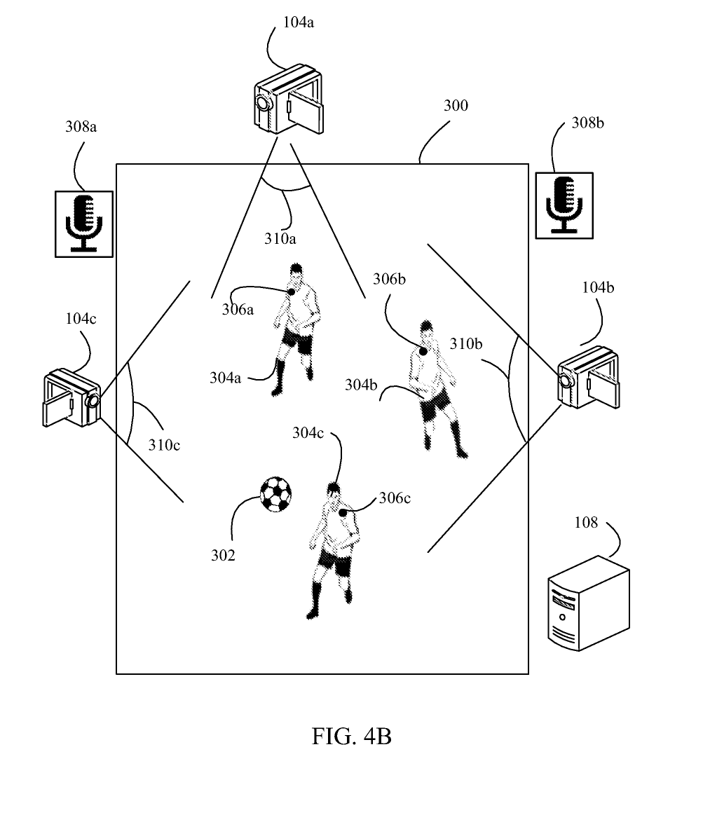

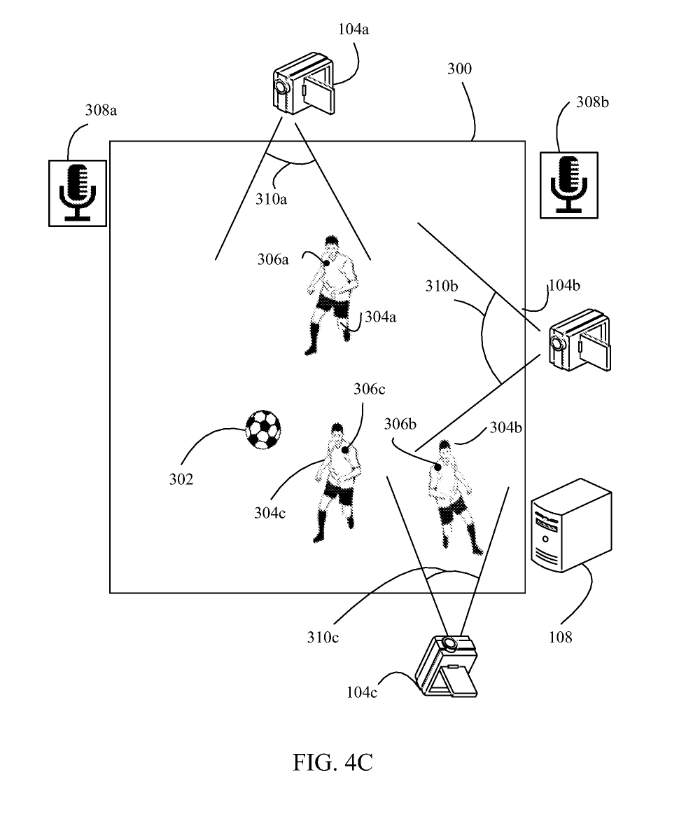

FIGS. 4A, 4B, and 4C illustrate examples of tracking two or more objects based on a multi-camera system, in accordance with an embodiment of the disclosure. The examples of FIGS. 4A, 4B, and 4C are explained in conjunction with elements from FIG. 1, FIG. 2, FIG. 3A, FIG. 3B, and FIG. 3C.

With reference to FIGS. 4A, 4B, and 4C, there is shown the soccer field 300, the soccer ball 302, the first player 304a, the second player 304b, and the third player 304c (hereinafter referred to as players 304), which have already been described in detail with reference to FIGS. 3A, 3B, and 3C.

FIGS. 4A, 4B, and 4C further show the first GPS sensor 306a, the second GPS sensor 306b, the third GPS sensor 306c, the first microphone 308a, and the second microphone 308b, that have already been described in detail with reference to FIGS. 3A, 3B, and 3C. In an embodiment, a Bluetooth sensor (not shown in FIGS. 4A, 4B, and 4C) may be embedded inside the soccer ball 302.

FIGS. 4A, 4B, and 4C further show the controlling device 108 and one or more cameras such as the first camera 104a, the second camera 104b, and the third camera 104c, which have already been described in detail with reference to FIG. 1. FIGS. 4A, 4B, and 4C further illustrates the first field of view 310a of the first camera 104a, the second field of view 310b of the second camera 104b, and the third field of view 310c of the third camera 104c, which have already been described in detail with reference to FIGS. 3A, 3B, and 3C.

In an embodiment, the controlling device 108 may receive metadata identifying two or more players to be tracked. For example, a user associated with the controlling device 108 may enter the names of the first player 304a and the second player 304b to specify the first player 304a and the second player 304b as objects to be tracked. Based on the names of the first player 304a and the second player 304b, entered by the user, the controlling device 108 may determine a current location of the first player 304a and the second player 304b relative to the cameras 104. The controlling device 108 may determine the current location of the first player 304a and the second player 304b based on the one or more signals transmitted by the first GPS sensor 306a, the second GPS sensor 306b, the third GPS sensor 306c, the first microphone 308a, the second microphone 308b, and the Bluetooth sensor. Based on the names of the first player 304a and the second player 304b, the controlling device 108 may select one or more sensors capable of identifying a current location of the first player 304a and the second player 304b. For example, the controlling device 108 may select the first GPS sensor 306a and the second GPS sensor 306b, coupled to clothes worn by each of the first player 304a and the second player 304b, to determine a location of the first player 304a and the second player 304b. In another example, when the controlling device 108 is unable to receive one or more signals from the first GPS sensor 306a and the second GPS sensor 306b coupled to clothes of the first player 304a and the second player 304b, the controlling device 108 may select the first microphone 308a to determine a location of the first player 304a and the second player 304b.

FIG. 4A illustrates that the first player 304a and the second player 304b may be currently located at respective first locations. Based on the current locations of the first player 304a and the second player 304b, the controlling device 108 may select a camera to simultaneously track the first player 304a and the second player 304b. For example, the controlling device 108 may select the first camera 104a when the first camera 104a is closest to the current locations of the first player 304a and the second player 304b. In another example, the controlling device 108 may select the first camera 104a when both the first player 304a and the second player 304b are in the first field of view 310a of the first camera 104a. When the first player 304a and the second player 304b may move across the soccer field 300, the first camera 104a may track the first player 304a and the second player 304b.

When the first player 304a and the second player 304b may move across the soccer field 300, the controlling device 108 may adjust the pan, zoom, and/or tilt of the first camera 104a such that both the first player 304a and the second player 304b remain within the first field of view 310a of the first camera 104a. When the first player 304a and/or the second player 304b may move out of the first field of view 310a of the first camera 104a, the controlling device 108 may select another camera to track the first player 304a and the second player 304b.

FIG. 4B illustrates that the second player 304b may move to a second location on the soccer field 300 while the first player 304a may remain at the first location. The second location of the second player 304b may be such that the second player 304b is out of the first field of view 310a of the first camera 104a. In such a case, the controlling device 108 may select another camera closer to the second location of the second player 304b. For example, the controlling device 108 may select the second camera 104b such that the second player 304b may lie in the second field of view 310b of the second camera 104b. The controlling device 108 may continue to track the first player 304a by the first camera 104a. When the second player 304b again moves closer to the first camera 104a, the controlling device 108 may switch again to the first camera 104a to track the second player 304b.

In an embodiment, the second player 304b may move to a location on the soccer field 300 such that the second player 304b may not lie in the field of view of any of the first camera 104a, the second camera 104b, and the third camera 104c. In such a case, the controlling device 108 may change the position of the movable camera. For example, the controlling device 108 may move the third camera 104c to another location.

FIG. 4C illustrates that the third camera 104c may be moved from a first position (shown in FIG. 4A) to a second position, in real time, based on a change in location of the second player 304b. When the third camera 104c is at the second position, the second player 304b may lie in the third field of view 310c of the third camera 104c. Although the disclosure describes using a single camera to simultaneously track two or more objects, one skilled in the art may appreciate that the disclosure can be implemented for tracking two or more objects by any number of cameras.

In an embodiment, each of the cameras 104 may individually track a particular player. For example, the first camera 104a, the second camera 104b, and the third camera 104c may track the first player 304a, the second player 304b, and the third player 304c, respectively.

In an embodiment, images and/or videos of each of the players 304 captured by the respective cameras 104 may be displayed to a user associated with the controlling device 108. The user may select which players may be tracked based on the displayed images and/or videos. In an embodiment, the user may add more players to a list of already tracked players. In another embodiment, the user may remove players from a list of tracked players. Based on the number of players added and/or removed by the user, the controlling device 108 may change the display.

In an embodiment, the user may specify to display only those images and/or videos in which both the first player 304a and the second player 304b may be seen. When none of the cameras 104 are able to capture images and/or videos in which both the first player 304a and the second player 304b are visible, the controlling device 108 may not display any image and/or video. Alternatively, the controlling device 108 may display a default image and/or video.

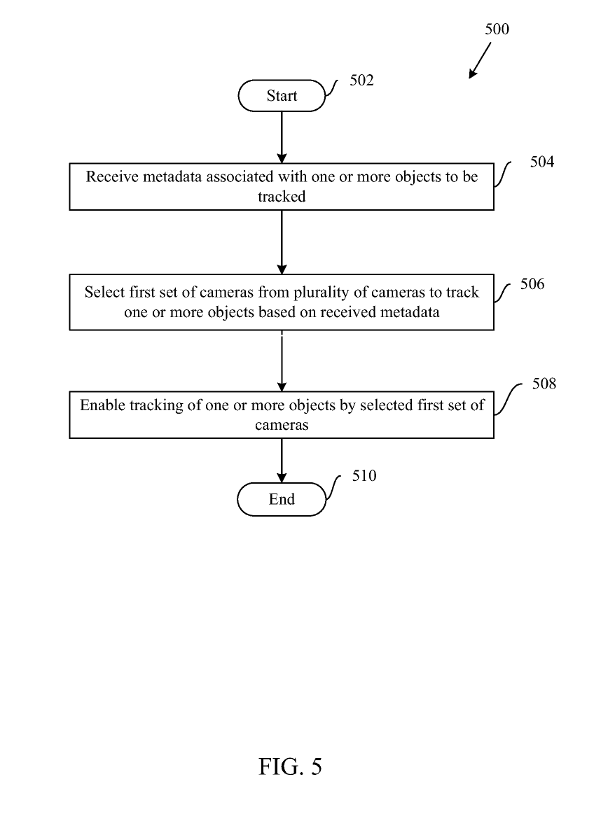

FIG. 5 is a flow chart illustrating exemplary steps for tracking one or more objects by a controlling device, in accordance with an embodiment of the disclosure. With reference to FIG. 5, there is shown a method 500. The method 500 is described in conjunction with elements of FIG. 1 and FIG. 2.

Exemplary steps begin at step 502. At step 504, the processor 202 may receive metadata associated with one or more objects to be tracked, such as the first object 102a. The metadata identifies the first object 102a. At step 506, the processor 202 may select a first set of cameras (such as the first camera 104a) from the plurality of cameras (such as the cameras 104) to track the one or more objects based on the received metadata. At step 508, the processor 202 may enable tracking of the one or more objects by the selected first set of cameras. The method 500 ends at step 510.

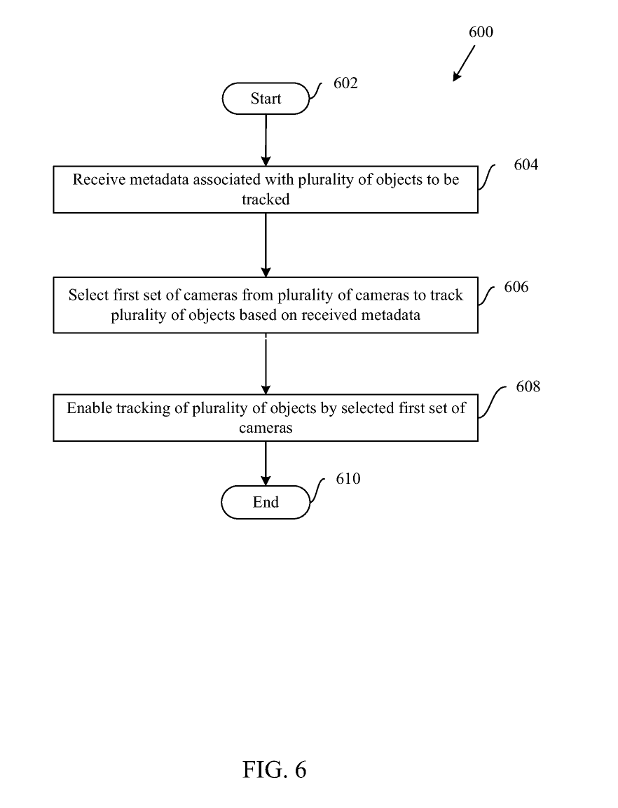

FIG. 6 is a flow chart illustrating exemplary steps for tracking plurality of objects by a controlling device, in accordance with an embodiment of the disclosure. With reference to FIG. 6, there is shown a method 600. The method 600 is described in conjunction with elements of FIG. 1 and FIG. 2.

Exemplary steps begin at step 602. At step 604, the processor 202 may receive metadata associated with plurality of objects to be tracked, such as the first object 102a and the second object 102b. The metadata identifies the first object 102a and the second object 102b. At step 606, the processor 202 may select a first set of cameras (such as the first camera 104a) from the plurality of cameras (such as the cameras 104) to track the plurality of objects based on the received metadata. At step 608, the processor 202 may enable tracking of the plurality of objects by the selected first set of cameras. The method 600 ends at step 610.

In accordance with an embodiment of the disclosure, a system, such as the multi-camera system 100 (FIG. 1), for tracking one or more objects 102 (FIG. 1) may comprise a network, such as the communication network 110 (FIG. 1). The network may be capable of communicatively coupling a plurality of cameras 104 (FIG. 1), a plurality of sensors 106 (FIG. 1), and a controlling device 108 (FIG. 1). The controlling device 108 may comprise one or more processors, such as a processor 202 (FIG. 2). The one or more processors may be operable to receive metadata associated with the one or more objects 102. The metadata identifies the one or more objects 102. The one or more processors may be operable to select a first set of cameras, such as the first camera 104a (FIG. 1), from the plurality of cameras 104 to track the one or more objects 102 based on the received metadata. The one or more processors may be operable to enable tracking of the one or more objects 102 by the selected first set of cameras.

The one or more processors may be operable to select a second set of cameras, such as the second camera 104b (FIG. 1), from the plurality of cameras 104 to track the one or more objects 102 when the one or more objects 102 move out of a field of view of one or more cameras of the selected first set of cameras.

The one or more processors may be operable to receive one or more signals from the plurality of sensors 106. A location of the one or more objects 102 relative to the plurality of cameras 104 may be determined based on the received one or more signals. The one or more processors may be operable to determine a direction and a distance of the one or more objects 102 relative to the plurality of cameras 104 based on the one or more signals received from the plurality of sensors 106.

The plurality of sensors 106 may comprise audio sensors, position sensors, Radio Frequency Identification (RFID) sensors, Infra-Red (IR) sensors, Bluetooth sensors, Global Positioning System (GPS) sensors, Ultra-Violet (UV) sensors, or sensors operable to detect cellular network signals. The one or more processors may be operable to select a sensor, such as the first sensor 106a (FIG. 1), from the plurality of sensors 106 based on the received one or more signals. The one or more processors may be operable to enable tracking of the one or more objects 102 by the selected first set of cameras based on a signal received from the selected sensor. A direction and a distance of the one or more objects 102 relative to the selected first set of cameras may be determined based on the signal received from the selected sensor.

The one or more processors may be operable to select the sensor from the plurality of sensors 106 based on one or more of: the one or more objects 102 to be tracked, the direction and the distance of said one or more objects 102 to be tracked, and/or a range of the plurality of sensors 106.

The one or more processors may be operable to change a position of the selected first set of cameras based on one or more of: the one or more objects 102 to be tracked, and/or said direction and said distance of the one or more objects 102 relative to the selected first set of cameras.

The one or more processors may be operable to control one or more parameters of the selected first set of cameras based on one or more of: the one or more objects 102 to be tracked, a location of the one or more objects 102, the direction and the distance of the one or more objects 102 relative to the selected first set of cameras, and/or one or more instructions provided by a user associated with the controlling device 108. The one or more parameters of the selected first set of cameras may comprise camera zoom, camera tilt, camera pan, and/or position of the selected first set of cameras.

The selected first set of cameras may satisfy one or more pre-determined criteria. The pre-determined criteria may comprise an angle from which an image of the one or more objects 102 is to be captured, a quality of the image, a distance of the one or more objects 102 from the plurality of cameras 104, a field of view of the plurality of cameras 104, and/or a degree of zoom, pan, and/or tilt required by the plurality of cameras 104 to capture the image of the one or more objects 102.

The one or more processors may be operable to dynamically control operations and/or settings of one or more devices external to the network. The one or more external devices are located within a pre-determined proximity to the one or more objects 102 to be tracked. The one or more processors may be operable to dynamically control the one or more external devices based on one or more of: the one or more objects 102 to be tracked, a location of the one or more objects 102 relative to the one or more external devices, settings required by the selected first set of cameras, and/or preference of a user associated with the controlling device 108.

The metadata may comprise one or more of: names of the one or more objects 102, images of the one or more objects 102, unique identifiers associated with the one or more objects 102, sounds associated with the one or more objects 102, and/or audio-visual identifiers associated with the one or more objects 102. The one or more processors may be operable to crop an image captured by the selected first set of cameras based on a position of the one or more objects 102 in the image.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps comprising receiving metadata associated with the plurality of objects. The metadata identifies the plurality of objects. A first set of cameras from the plurality of cameras may be selected to track the plurality of objects based on the received metadata. The plurality of objects may be tracked by the selected first set of cameras.

Accordingly, the present disclosure may be realized in hardware, or a combination of hardware and software. The present disclosure may be realized in a centralized fashion in at least one computer system or in a distributed fashion where different elements may be spread across several interconnected computer systems. Any kind of computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A system for tracking one or more objects, said system comprising:
in a network capable of communicatively coupling a plurality of cameras, a plurality of sensors, and a controlling device, one or more processors in said controlling device being operable to:
receive metadata associated with said one or more objects, wherein said metadata identifies said one or more objects;
select a Radio Frequency Identification (RFID) sensor associated with said one or more objects, from said plurality of sensors, based on one or more signals received from said plurality of sensors;
select a first set of cameras from said plurality of cameras to track said one or more objects based on said received metadata; and
enable tracking of said one or more objects by said selected first set of cameras based on a signal received from said selected RFID sensor.

2. The system of claim 1, wherein said one or more processors are operable to select a second set of cameras from said plurality of cameras for tracking said one or more objects when said one or more objects moves out of a field of view of one or more cameras of said selected first set of cameras.

3. The system of claim 1, wherein said one or more processors are operable to:
receive said one or more signals from said plurality of sensors, wherein a location of said one or more objects relative to said plurality of cameras is determined based on said received one or more signals; and
determine a direction and a distance of said one or more objects relative to said plurality of cameras based on said one or more signals received from said plurality of sensors.

4. The system of claim 1, wherein said plurality of sensors comprises audio sensors, position sensors, Radio Frequency Identification (RFID) sensors, Infra-Red (IR) sensors, Bluetooth sensors, Global Positioning System (GPS) sensors, Ultra-Violet (UV) sensors, or sensors operable to detect cellular network signals.

5. The system of claim 1, wherein a direction and a distance of said one or more objects relative to said selected first set of cameras is determined based on said signal received from said selected RFID sensor.

6. The system of claim 1, wherein said one or more processors are operable to select said RFID sensor from said plurality of sensors based on one or more of: said one or more objects to be tracked, a direction and a distance of said one or more objects to be tracked relative to said selected first set of cameras, and a range of said plurality of sensors.

7. The system of claim 1, wherein said one or more processors are operable to change a position of said selected first set of cameras based on one or more of: said one or more objects to be tracked, and a direction and a distance of said one or more objects relative to said selected first set of cameras.

8. The system of claim 1, wherein said one or more processors are operable to control one or more parameters of said selected first set of cameras based on one or more of: said one or more objects to be tracked, a location of said one or more objects, and a direction and a distance of said one or more objects relative to said selected first set of cameras.

9. The system of claim 8, wherein said one or more processors are operable to control said one or more parameters of said selected first set of cameras based on one or more instructions provided by a user associated with said controlling device.

10. The system of claim 8, wherein said one or more parameters of said selected first set of cameras comprise camera zoom, camera tilt, camera pan, and a position of said selected first set of cameras.

11. The system of claim 1, wherein said selected first set of cameras satisfies one or more pre-determined criteria.

12. The system of claim 11, wherein said pre-determined criteria comprise:
an angle from which an image of said one or more objects is to be captured,
a quality of said image,
a distance of said one or more objects from said plurality of cameras,
a field of view of said plurality of cameras, and
a degree of zoom, pan, and/or tilt required by said plurality of cameras to capture said image of said one or more objects.

13. The system of claim 1, wherein said one or more processors are operable to dynamically control operations and/or settings of one or more devices external to said network, wherein said one or more external devices are located within a predetermined proximity to said one or more objects to be tracked.

14. The system of claim 13, wherein said one or more processors are operable to dynamically control said one or more external devices based on one or more of: said one or more objects to be tracked, a location of said one or more objects relative to said one or more external devices, and settings required by said selected first set of cameras.

15. The system of claim 13, wherein said one or more processors are operable to dynamically control said one or more external devices based on preference of a user associated with said controlling device.

16. The system of claim 1, wherein said metadata comprises one or more of: names of said one or more objects, images of said one or more objects, unique identifiers associated with said one or more objects, sounds associated with said one or more objects, and audio-visual identifier associated with said one or more objects.

17. The system of claim 1, wherein said one or more processors are operable to crop a portion of an image signal received from said selected first set of cameras such that said cropped portion of said image signal includes said one or more objects to be tracked.

18. A method for tracking a plurality of objects by a controlling device, said method comprising:
in a network capable of communicatively coupling a plurality of cameras, a plurality of sensors, and said controlling device:
receiving metadata associated with each of said plurality of objects, wherein said metadata identifies each of said plurality of objects;
selecting a Radio Frequency Identification (RFID) sensor associated with said plurality of objects, from said plurality of sensors, based on one or more signals received from said plurality of sensors;
selecting a first set of cameras from said plurality of cameras to track said plurality of objects based on said received metadata; and
enabling tracking of said plurality of objects by said selected first set of cameras, wherein a camera of said first set of cameras simultaneously tracks said plurality of objects.

19. The method of claim 18, further comprising selecting a second set of cameras from said plurality of cameras for tracking one or more objects of said plurality of objects when said one or more objects move out of a field of view of one or more cameras of said selected first set of cameras.

20. The method of claim 18, further comprising:
receiving said one or more signals from said plurality of sensors, wherein a location of said plurality of objects relative to said plurality of cameras is determined based on said received one or more signals; and
enabling tracking of said plurality of objects by said selected first set of cameras based on a signal received from said selected RFID sensor, wherein a location of said plurality of objects relative to said selected first set of cameras is determined based on said signal received from said selected RFID sensor.

21. The method of claim 18, further comprising controlling one or more parameters of said camera of said selected first set of cameras based on a distance between said plurality of objects to be tracked.

22. The method of claim 18, further comprising cropping a portion of an image signal received from said selected first set of cameras such that said cropped portion of said image signal includes said plurality of objects to be tracked.

23. The system of claim 1, wherein said one or more processors are operable to select said RFID sensor from said plurality of sensors based on a current location of said one or more objects to be tracked.

24. The system of claim 1, wherein said one or more objects tracked by said selected said first set of cameras are not visible in a plurality of images captured by said first set of cameras.

25. The system of claim 1, wherein said one or more processors are further operable to control parameters associated with an environment within a predetermined proximity to said one or more objects to be tracked.

26. The system of claim 1, wherein one or more processors are further operable to select said RFID sensor associated with said one or more objects, from said plurality of sensors, based on said received metadata identifying said one or more objects.
